(19) United States
(12) Patent Application Publication
(10) Pub. No.: US 2026/0296082 A1
(43) Pub. Date: Oct. 1, 2026

(54) METHOD AND SYSTEM OF SUBLIMATIC PRINTING A HOLLOW BODY

(71) Applicant: ATIU S.R.L., Sona (VR) (IT)

(72) Inventors: Tito TREVISAN, SONA (VR) (IT); Alessandro VOLPATO, SONA (VR) (IT)

(73) Assignee: ATIU S.R.L., SONA (VR) (IT)

(21) Appl. No.: 19/489,087

(22) PCT Filed: May 30, 2024
(86) PCT No.: PCT/IB2024/055275

§ 371 Date: Dec. 1, 2025

(30) Foreign Application Priority Data
Jun. 1, 2023 (IT) 102023000011223

(51) Int. Cl. B41M 5/035; B29C 65/66; B41F 16/00

(52) U.S. Cl. CPC B41M 5/0353; B41F 16/0086; B29C 65/66

(57) ABSTRACT

A method of printing a hollow body having a continuous edge delimiting an end zone involves shrinking a heat-shrinkable sleeve having an inner face printed with sublimation inks around the hollow body so as to form a film, which is arranged around the hollow body and has an end flap turned up around the continuous edge within the end zone; pushing the assembly formed by the hollow body and film at the edge against an elastically yielding layer of a sealing device; bringing the assembly to a sublimation temperature of the sublimation inks; and, simultaneously, aspirating air and gas from a plurality of microchannels arranged between the film and the hollow body.

### CROSS-REFERENCE TO RELATED APPLICATIONS

This Patent Application claims priority from Italian Patent Application No. 102023000011223 filed on Jun. 1, 2023, the entire disclosure of which is incorporated herein by reference.

### TECHNICAL FIELD

This invention relates to a method of sublimation printing a hollow body that has an edge delimiting an end zone, in particular for printing external surfaces of hollow containers like bottles, containers, and glass or ceramic vessels, or those made of similar materials.

### STATE OF THE ART

Specific equipment and processes are known for creating decorations via the heated transfer of inks, in particular via sublimation printing.

In this sector, there is a growing demand for sublimation printing of a high quality, like, for example, high definition of the design and precise affixing of decorations or writing in relation to specific reference points of the hollow body.

In particular, the patent WO 2021/260613 A1 instructs how to affix decorations on glass hollow bodies and the like, such as bottles or containers via a sublimation printing process with high quality levels in terms of definition of the decorations and precision of affixing the same. The process described in this patent right involves creating a sleeve, which has an irregular inner face, is obtained from a sheet of film made of thermoplastic material, generally PET or PETG, wound to form a cylinder and heat sealed on the flaps with glue or solvent of the polymer itself using a seaming machine and bears a design along its irregular inner face. The design is created directly on the film with a sublimation ink that is intended to be transferred to the hollow body to be decorated via a sublimation process.

The process, as a whole, involves arranging the sleeve around the hollow body, applying heat to the sleeve so as to shrink it and make it adhere to the hollow body, applying heat at an ink sublimation temperature to the sleeve and to the hollow body to sublimate the ink particles, and transferring the design onto the hollow body while, simultaneously, extracting the excess gas produced in the sublimation through a network of microchannels that extend between the shrunk sleeve and the hollow body. The microchannels present between the hollow body and the shrunk sleeve are formed thanks to the fact that the sleeve has an irregular or rough inner face that is prepared to form the microchannels once the sleeve has been shrunk to form a film adhering to the hollow body.

The process described in WO 2021/260613 A1 is particularly satisfactory since it concerns the qualitative aspects. In any case, one of the problems that is encountered in sublimation printing is that of combining a high quality level with efficient industrialisation of the production process so as to reduce the production costs.

### SUBJECT OF THE INVENTION

One purpose of this invention is to provide a method of sublimation printing hollow bodies, which can be industrialised simply and effectively.

In accordance with this invention, a method of printing a hollow body having a continuous edge delimiting an end zone is provided; the method comprising:
shrinking a heat-shrinkable sleeve having an inner face printed with sublimation inks around the hollow body so as to form a film, which is arranged around the hollow body and has an end flap turned up around the continuous edge within the end zone;
pushing the assembly formed by the hollow body and film at the edge against an elastically yielding layer of a sealing device;
bringing the assembly to a sublimation temperature; and
simultaneously aspirating air and gas from a plurality of microchannels arranged between the film and the hollow body.

In accordance with this invention, the connection between the assembly and a suction or vacuum source simply requires pushing the assembly on the elastically yielding layer of a support device and aspirating the air through microchannels. This technical solution enormously simplifies the equipment needed to implement the process and the process itself.

Advantageously, the method involves aspirating air and gas through the sealing device from said end zone.

In particular, the method involves fitting the heat shrinkable sleeve around the hollow body so that the end flap of the sleeve protrudes from the edge of the hollow body; turning up the end flap by heat shrinking around the edge so that it extends into the end zone.

In this way, the end flap turned up inside the cavity of the hollow body actually defines, together with the hollow body itself, the evacuation zone of the microchannels.

In accordance with one embodiment of this invention, an end flap projects from the edge of the hollow body so as to form an appendage in the shrinking step, the method comprising the step of heat sealing the appendage so as to make aspiration in the microchannels more effective.

Another purpose of this invention is to provide a system for sublimation printing of hollow bodies, which is free from the drawbacks of the prior art.

In accordance with this invention, a system for sublimation printing of hollow bodies that have an edge delimiting an end zone is provided, the system comprising a sublimation oven; at least one sealing device configured to be arranged in contact with an assembly formed by a hollow body wrapped in a film having an end flap arranged within a respective end zone bounded by an edge of the hollow body, wherein the sealing device comprises a rigid body and an elastically yielding layer along at least the contact portion of the hollow body defined by said edge covered by said film.

In this method, the support device has the function of preventing or, at least, limiting aspirating air outside the end zone circumscribed by the edge.

Conveniently, the sealing device comprises at least one opening in communication with a suction source for aspirating air through the sealing device.

In particular, it was found that the elastically yielding layer with a hardness ranging between 20 and 80 shore demonstrates good performance.

In accordance with one variant the support device comprises an intermediate layer comprising an element with cavities and saliencies along the face turned towards the elastically yielding layer with the purpose of exerting a non-uniform pressure on the edge of the hollow body and preventing the closure of the microchannels at the edge.

In particular, the intermediate layer comprises an elastically yielding material in which the element is embedded.

In accordance with one embodiment of this invention, the elastically yielding layer has a rest surface with a roughness Ra ranging between 5 and 200 microns so as to exert a non-uniform pressure along the continuous edge of the hollow body and prevent the closure of the microchannels at the continuous edge.

In particular, it was found that silicone is particularly appropriate for creating the elastically yielding layer due to its elastic properties and its capacity to maintain the elastic properties unchanged in a wide range of temperatures.

In particular, the system comprises two sealing devices configured to seal the assembly at opposite edges.

In this way, it is not necessary to heat seal the appendage and it is also possible to use a relatively short sleeve that only slightly exceeds the length of the hollow body.

### BRIEF DESCRIPTION OF THE DRAWINGS

Additional features and advantages of this invention will be clear from the description that follows of its non-limiting embodiments, with reference to the attached figures, in which:

FIG. 1 is a schematic view, with parts removed for clarity, of a system for sublimation printing.

FIGS. 2 and 3 are side elevation cross-section views, with parts removed for clarity, of a detail of the assembly station of the system in FIG. 1 in two respective operating steps;

FIG. 4 is a side elevation view, with parts removed for clarity and parts schematically depicted, of the assembly station of the system in FIG. 1;

FIG. 5 is a side elevation cross-section view, with parts removed for clarity, of an additional detail of the assembly station in FIG. 3;

FIG. 6 is a side elevation view, with parts removed for clarity, of the heat sealing station in FIG. 1;

FIG. 7 is a side elevation cross-section view, with parts removed for clarity, of a detail of the sublimation station of the system in FIG. 1;

FIG. 8 is a cross-section view, on an enlarged scale and with parts removed for clarity, of a detail in FIG. 7;

FIG. 9 is an exploded perspective view of the detail in FIG. 8;

FIG. 10 is a side elevation view, with parts removed for clarity, of a sublimation station of the system in FIG. 1;

FIG. 11 is a side elevation view, with parts removed for clarity, of the detail of the sublimation station in FIG. 8; and

FIG. 12 is a side elevation cross-section view, with parts removed for clarity, of a detail of a sublimation station in accordance with a variant of this invention.

### PREFERRED EMBODIMENT OF THE INVENTION

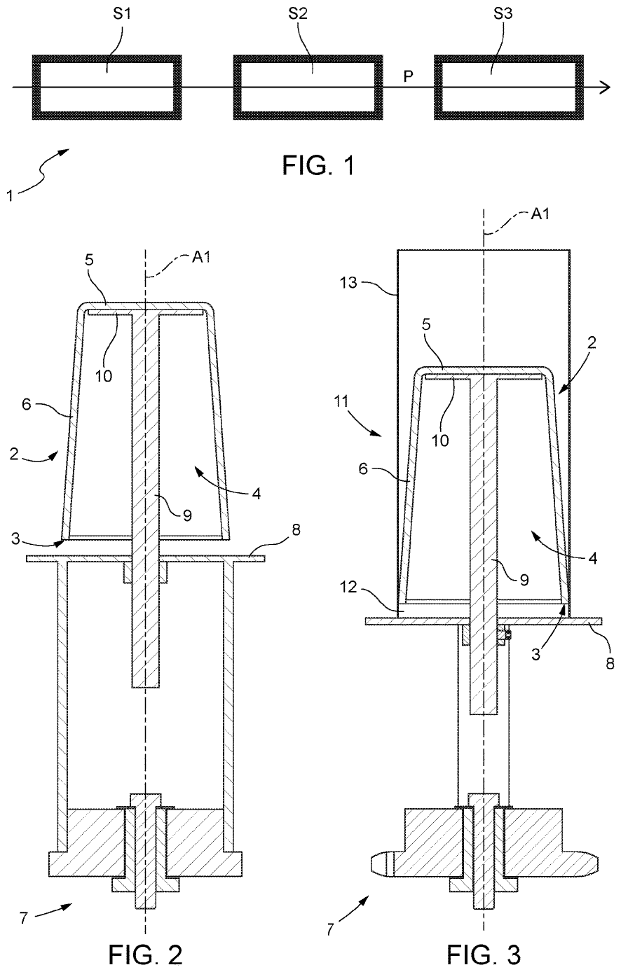

With reference to FIG. 1, reference number 1 illustrates, as a whole, a system for sublimation printing comprising an assembly station S1, a heat sealing station S2, and a sublimation station S3 arranged in sequence along a forward path P.

In FIG. 2, reference number 2 indicates a hollow body in the shape of a glass that has an edge 3, which is closed in a ring and circumscribes an end zone that, in the example illustrated, comprises a cavity 4. In the example illustrated, the hollow body 2 has a bottom wall 5 and a side wall 6, which terminates with the edge 3.

Reference number 7 indicates an assembly device, which extends along an axis A1 and comprises a plate 8, a shaft 9, which extends through the plate 8 and can be adjusted along the axis A1 in relation to the plate 8, and a rest element 10 arranged at the upper end of the shaft 9. The assembly device 7 is configured to support the hollow body 2, overturned and with the rest element 10 in contact with the inner face of the bottom wall 5 of the hollow body 2, and to maintain the edge 3 at a given distance from the plate 8.

With reference to FIG. 3, the plate 8 has the function of defining a rest surface for a sleeve 11 made of heat shrinkable material, which is fitted around the hollow body 2. The material is heat shrinkable only in the circumferential direction of the sleeve 11. In addition, the inner face of the sleeve 11 is rough or irregular so as to form a dense network of microchannels or shafts and printed with sublimation inks, when the sleeve 11 is shrunk and brought into contact with the hollow body 2. Alternatively, the printed inner face of the sleeve 11 is smooth while the outer face of the hollow body 2 is rough for similarly creating the dense network of microchannels when the sleeve 11 is shrunk and adheres to the outer face of the hollow body 2, in particular to the outer face of the side wall 6. The design is created directly on a sheet with a sublimation ink that is intended to be transferred to the hollow body 2 to be decorated. The sheet, conveniently heat sealed along two opposite ends, forms the sleeve 11 with the design arranged on the inner face of the sleeve 11.

The sleeve 11 has a greater height than the height of the hollow body 2 and has an end flap 12 projecting from the edge 3 and an end flap 13 that projects from the bottom wall 5.

The assembly device 7 thus makes it possible to precisely fit and position the sleeve 11 on the hollow body 2 so as to arrange the decorations in a given position in relation to certain reference points of the hollow body 2 and to appropriately adjust the projection of the flaps 12 and 13. In this case, the length of the end flap 12 is much smaller and just enough to turn the end flap 12 up around the edge 3 so as to prevent the turned-up end flap 12 from blocking the cavity 4. The end flap 13 is long enough to enable it to be united and heat sealed.

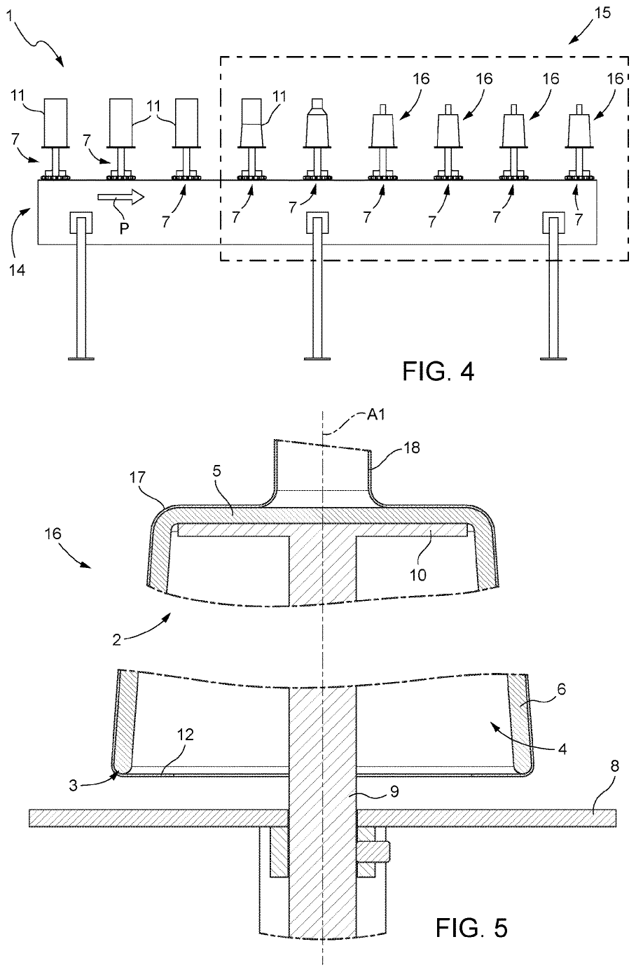

With reference to FIG. 4, the system 1 comprises a conveyor 14 to move the assembly device 7 forward along the path P through the assembly station S1, which comprises a heat shrinking furnace 15 in which the sleeve 11 is shrunk around the hollow body 2 so as to form an assembly 16 (FIG. 5) with the hollow body 2. The conveyor 14 is configured to move multiple assembly devices 7 forward in sequence and/or next to each other along the forward path P.

With reference to FIG. 5, the shrunk sleeve 11 actually forms a film 17 that adheres to the side wall 6 and to the bottom wall 5 of the hollow body 2, has an appendage 18 deriving from the contraction of the end flap 13 and has the end flap 12 turned up around the edge 3 and extending inside the end zone and, in this case, into the cavity 4.

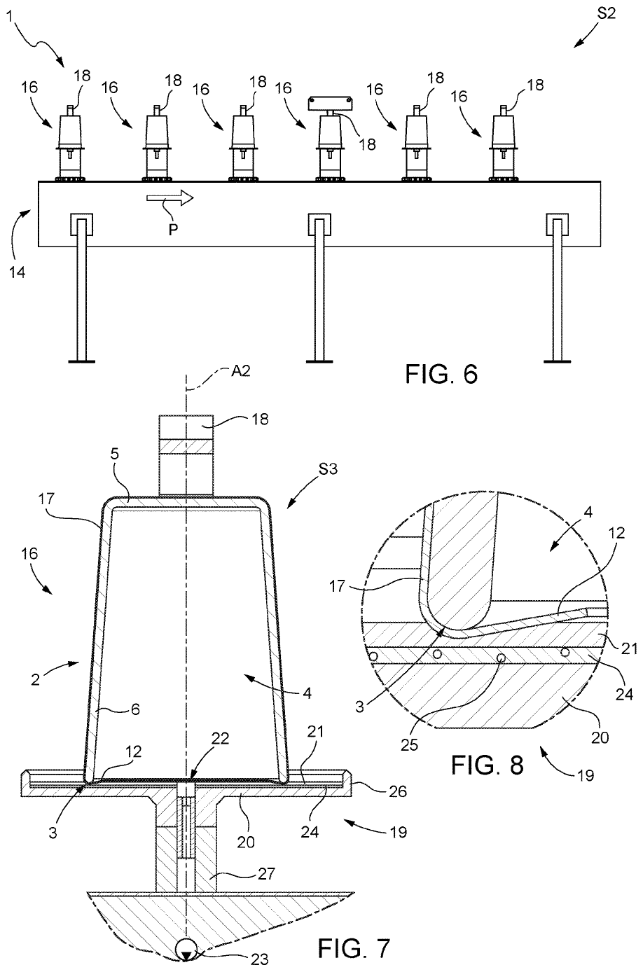

Subsequently, the assembly device 7 and the assembly 16 are moved forward using the conveyor 14 in the heat sealing station S2, in which the appendage 18 is heat sealed, as shown in FIG. 6.

With reference to FIG. 7, once the heat sealing operation is concluded, the assembly 16 is arranged on a corresponding sealing device 19, which is configured to be moved along the transportation path P through the sublimation station S3 (FIG. 10). In the example illustrated, the sealing device 19 also has the function of support device.

With reference to FIG. 8, the sealing device 19 comprises a rigid body 20, an elastically yielding layer 21 at least along the rest portion of the assembly 16 defined by the edge 3 covered by the film 17.

With reference to FIG. 7, the sealing device 19 has an opening 22 in communication with a suction source 23 for aspirating air through the stiff layer 20 and the elastically yielding layer 21.

With reference to FIG. 8, the elastically yielding layer 21 has the function of preventing air from being aspirated from the outside and conveniently has a hardness that ranges from 20 to 80 shore and is preferably made of silicone. The sealing device 19 also comprises an additional intermediate layer 24 of elastically yielding material, in which an element 25 is embedded that has its surface turned towards the elastically yielding layer 21 provided with indentations alternating with saliencies, preferably a metal net embedded in the intermediate layer 24. In the example illustrated in FIG. 8, the element 25 is defined by a net, in particular a metal net. The intermediate layer 24 is also traversed by the opening 22.

The elastically yielding layer 21 has a rest face with a roughness Ra ranging between 5 and 200 microns.

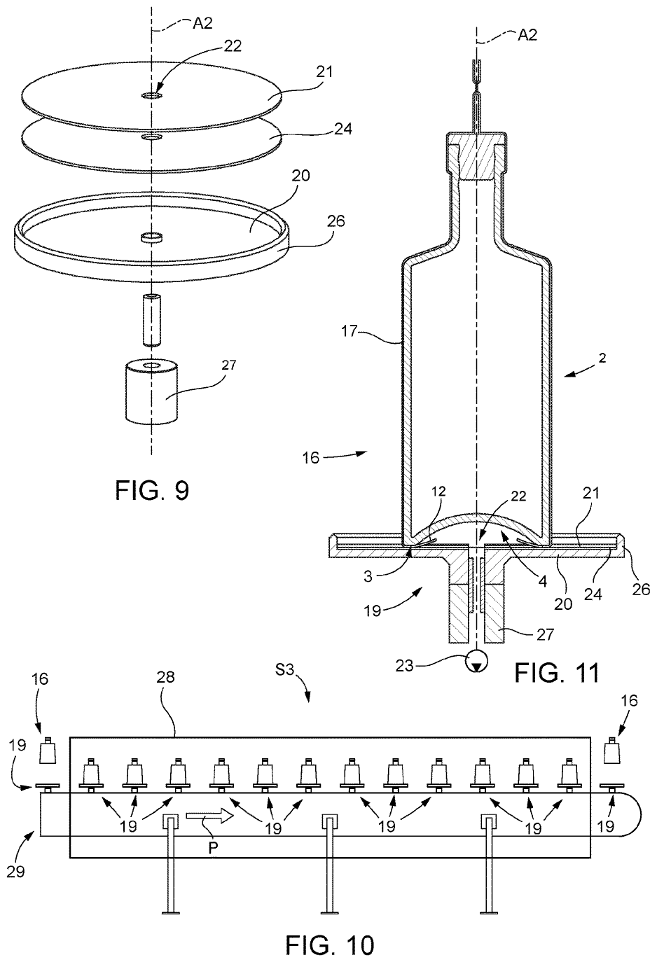

With reference to FIG. 9, the rigid layer 20 is basically a metal plate delimited on the outside by a side wall 26 to house the elastically yielding layer 21 and, potentially, the intermediate layer 24.

The sealing device 19 comprises a duct 27 that has the function of supporting the rigid body 20 at the opening 22 and is connected to the suction source 23 (FIG. 7).

With reference to FIG. 10, the sublimation station S3 comprises a sublimation oven 28 and a conveyor 29, which is configured to move multiple sealing devices 19 arranged in sequence forward through the sublimation oven 28.

In use, in the assembly station S1 (FIG. 4), the sleeve 11 is fitted around the hollow body 2 and retracted so as to form the film 17 with corresponding appendage 18 and the end flap 12 turned up around the edge 3 and extending inside the end zone, in this case in the cavity 4 of the hollow body 2 according to what is shown in FIG. 5.

After having heat sealed the appendage 18 in the heat sealing station S2 (FIG. 6), the assembly 16 formed by the hollow body 2 and the film 17 is transferred to the sublimation station S3 (FIG. 10) by the assembly device 7 to a sealing device 19 of the conveyor 29, which has the function of supporting the assembly 16 in the sublimation oven 28 (FIG. 10) and enabling the removal of gases and vapours that are generated during the sublimation between the film 17 and the hollow body 2.

Given the roughness of the inner face of the film 17 and/or the surface of the hollow body 2 to which the film 17 adheres, there are microchannels, not illustrated in the attached figures, between the film 17 and the hollow body 2, which enable the passage of air and gas.

When the assembly 16 is rested on the sealing device 19 at the edge 3 of the hollow body 2, the weight of the assembly 16 deforms the elastically yielding layer 21 at the edge 3 (FIG. 8). The surface roughness of the elastically yielding layer 21 and/or the presence of the intermediate layer 24 prevent the application of uniform pressure along the edge 3 and the closure of the microchannels at the edge 3 when the pressure exerted by the assembly 16 becomes significant. When the suction source 23 (FIG. 8) is activated, a void fraction is formed in the end zone, and the air and gases are evacuated through the microchannels. The void fraction in the end zone further increases the pressure exerted by the assembly 16 on the sealing device 19 and on the elastically yielding layer 21 and, thus, the seal limiting any entry of air from the outside that, in the trigger step, is tolerated.

In this step too, the roughness of the rest face of the elastically yielding layer 21 and/or the presence of the intermediate layer 24 prevent the closure of the microchannels, enabling the evacuation of air and gases from the printing surface.

According to one variant not illustrated in the attached figures, the sealing device has multiple openings connected to the suction source. In this way, the sealing device is able to simultaneously manage the same number of assemblies as there are openings, when the openings are spaced apart enough from each other and the dimensions of the assemblies allow it.

According to the variant not illustrated, the intermediate layer is omitted and a net is arranged directly between the rigid layer and the elastically yielding layer.

The description of this invention makes specific reference to hollow bodies that have the shape of a glass or vessel but is also applicable to hollow bodies with a different shape like, for example, bottles provided with an end zone as illustrated in FIG. 11.

In this case, the hollow body 2, in this case a bottle, has an edge 3 that delimits the cavity 4 of the bottom of the bottle. The process and system of sublimation are the same used for vessels and glasses. In this case, it is appropriate to stop the bottle to avoid tensions in the film 17 at the opening of the same in the aspiration step.

In accordance with an additional variant, the end zone of the container is flat, i.e. it has no indentations or cavities.

In order to evacuate the gases from the microchannels, it is important that the end flap folded along the end zone is not heat sealed so as to enable the fluidic communication between the microchannels and the vacuum source and it has been checked that the fluidic communication is possible even in the absence of cavities or indentations.

In addition, although the attached figures show sealing devices with a flat face, it is understood that the face of the sealing device may assume any configuration with the single caution that it is able to follow the continuous edge of the hollow body.

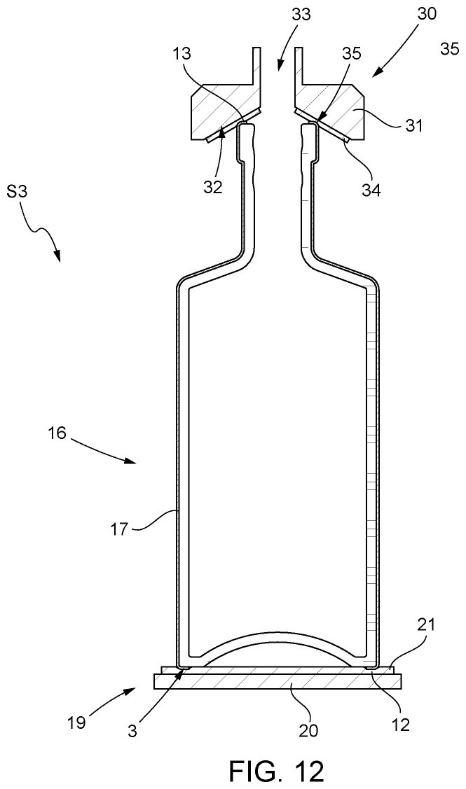

In accordance with an additional variant illustrated in FIG. 12, the sublimation station S3 comprises, in addition to the sealing device 19, another sealing device 30 that is arranged on the opposite side to the first sealing device 19 and is configured to be selectively arranged in contact with the end of the assembly 16 opposite the one arranged on the first sealing device 19. The sealing device 30 has a rigid body 31 that has a truncated cone face 32; an opening 33 in communication with a suction source; and an elastically yielding layer 34 arranged along the truncated cone face 32. Between the rigid body 31 and the elastically yielding layer 34, it is possible to arrange an intermediate layer similar to the intermediate layer 24 (FIG. 8).

In use, the hollow body 2 is defined by a bottle, is covered in a film 17 and is clamped between the sealing devices 19 and 30. As well as having the edge 3 that circumscribes a respective end zone, the hollow body 2 has an additional edge 35 that circumscribes a respective end zone on the opposite side to the edge 3.

One benefit deriving from this embodiment consists in the fact that it is not necessary to heat seal the appendage 18 (FIG. 7) so that the heat sealing station S2 (FIGS. 1 and 6) is omitted. In addition, this technical solution makes it possible to significantly shorten the end flap 13 with a considerable saving in material. The suction through the sealing device 19 can also be omitted. Alternatively, the sealing device 30 may not have an opening or an aspirating function. In practice, it is possible to implement the aspiration on two sides or only on one of the two. In this embodiment, both the end flaps 12 and 13 are very short, i.e. their length enables their being turned up on corresponding edges 3 and 35 without projecting from the edges 3 and 35, enabling, among other things, a significant saving in thermoplastic film.

Finally, it is clear that, this invention comprises additional variants of the embodiments described and included within the scope of protection of the attached claims.

1. A method of sublimation printing a hollow body having a continuous edge delimiting an end zone; the method comprising:
shrinking a heat-shrinkable sleeve having an inner face printed with sublimation inks around the hollow body so as to form a film, which is arranged around the hollow body and has an end flap turned up around the continuous edge within the end zone;
push the assembly formed by the hollow body and film at the edge against an elastically yielding layer of a sealing device;
bring the assembly to a sublimation temperature; and
simultaneously aspirating air and gas from a plurality of microchannels arranged between the film and the hollow body.

2. The method as claimed in claim 1, comprising aspirating air and gas through the sealing device from said end zone.

3. The method as claimed in claim 1, comprising fitting the heat shrinkable sleeve around the hollow body so that the end flap of the sleeve protrudes from the edge of the hollow body; folding the end flap by heat shrinking around the edge so that it protrudes into the end zone.

4. The method as claimed in claim 3, wherein an end flap protrudes with respect to the edge of the hollow body so as to form an appendage in the heat shrinking step, the method comprising the step of heat sealing the appendage.

5. A system for sublimation printing of hollow bodies having an edge delimiting an end zone, the system comprising a sublimation oven; at least one sealing device configured to be arranged in contact with an assembly formed by a hollow body wrapped in a film having an end flap arranged within a respective end zone bounded by an edge of the hollow body, wherein the sealing device comprises a rigid body and an elastically yielding layer along at least the contact portion of the hollow body defined by said edge covered by said film.

6. The system as claimed in claim 5, wherein the sealing device comprises at least one opening in communication with a suction source for drawing air through the sealing device.

7. The system as claimed in claim wherein the elastically yielding layer has a hardness between 20 and 80 shore.

8. The system as claimed in claim 5, wherein the sealing device comprises an intermediate layer comprising an element having indentations and saliencies along the face facing the elastically yielding layer.

9. The system as claimed in claim 8, wherein the intermediate layer comprises an elastically yielding material in which the element is embedded.

10. The system as claimed in claim 5, wherein the elastically yielding layer has a free surface with a roughness Ra between 5 to 200 microns.

11. The system as claimed in claim 5, wherein the elastically yielding layer is made of silicone.

12. The system as claimed in claim 5, wherein the filling device has a plurality of apertures connected to a suction source.

13. The system as claimed in claim 5 and comprising two sealing devices configured to clamp the assembly at two opposite edges.

1. A method of sublimation printing a hollow body having a continuous edge delimiting an end zone; the method comprising:
shrinking a heat-shrinkable sleeve (11) having an inner face printed with sublimation inks around the hollow body (2) so as to form a film (17), which is arranged around the hollow body (2) and has an end flap (12; 13) turned up around the continuous edge (3; 35) within the end zone;
push the assembly (16) formed by the hollow body (2) and film (17) at the edge (3; 35) against an elastically yielding layer (21; 34) of a sealing device (19; 30) ;
bring the assembly (16) to a sublimation temperature; and
simultaneously aspirating air and gas from a plurality of microchannels arranged between the film (17) and the hollow body (2).

2. The method as claimed in claim 1, comprising aspirating air and gas through the sealing device (19; 30) from said end zone.

3. The method as claimed in claim 1 or 2, comprising fitting the heat shrinkable sleeve (11) around the hollow body so that the end flap (12; 13) of the sleeve (11) protrudes from the edge (3; 35) of the hollow body (2); folding the end flap (12; 13) by heat shrinking around the edge (3; 35) so that it protrudes into the end zone.

4. The method as claimed in claim 3, wherein an end flap (13) protrudes with respect to the edge (35) of the hollow body (2) so as to form an appendage (18) in the heat shrinking step, the method comprising the step of heat sealing the appendage (18).

5. A system for sublimation printing of hollow bodies having an edge delimiting an end zone, the system comprising a sublimation oven (28); at least one sealing device (19; 30) configured to be arranged in contact with an assembly (16) formed by a hollow body (2) wrapped in a film (17) having an end flap (12; 13) arranged within a respective end zone bounded by an edge (3; 35) of the hollow body (2), wherein the sealing device (19; 30) comprises a rigid body (20; 31) and an elastically yielding layer (21; 34) along at least the contact portion of the hollow body (2) defined by said edge (3; 35) covered by said film (17).

6. The system as claimed in claim 5, wherein the sealing device (19; 30) comprises at least one opening (22; 33) in communication with a suction source (23) for drawing air through the sealing device (19; 30).

7. The system as claimed in claim 5 or 6, wherein the elastically yielding layer (21; 34) has a hardness between 20 and 80 shore.

8. The system as claimed in any one of claims 5 to 7, wherein the sealing device (19; 30) comprises an intermediate layer (24) comprising an element (25) having indentations and saliencies along the face facing the elastically yielding layer (21; 34).

9. The system as claimed in claim 8, wherein the intermediate layer (24) comprises an elastically yielding material in which the element (25) is embedded.

10. The system as claimed in any one of claims 5 to 9, wherein the elastically yielding layer (21; 34) has a free surface with a roughness Ra between 5 to 200 microns.

11. The system as claimed in any one of claims 5 to 10, wherein the elastically yielding layer (21; 34) is made of silicone.

12. The system as claimed in any one of claims 5 to 11, wherein the filling device (19) has a plurality of apertures (22) connected to a suction source (23).

13. The system as claimed in any one of claims 5 to 12 and comprising two sealing devices (19, 30) configured to clamp the assembly (16) at two opposite edges (3; 35).
